(19) United States
(12) Patent Application Publication
(10) Pub. No.: US 2006/0123167 A1
(43) Pub. Date: Jun. 8, 2006

(54) Request conversion

(76) Inventors: Roger C. Jeppsen, Gilbert, AZ (US); Nathan E. Marushak, Gilbert, AZ (US)

Correspondence Address: INTEL CORPORATION, P.O. BOX 5326, SANTA CLARA, CA, 95056-5326, US

(21) Appl. No.: 11/008,355

(22) Filed: Dec. 8, 2004

(51) Int. Cl. G06F 13/42

(52) U.S. Cl. 710/106; 710/310

(57) ABSTRACT

In one embodiment, if the amount of data requested by a data transfer request according to a first protocol exceeds a maximum permitted for a single data transfer request according to a second protocol, a data structure and one data transfer request according to the second protocol may be generated. The request may request a portion of the data. If a target of the request is capable of receiving, prior to completion of performance of the request, another data transfer request according to the second protocol, the another data transfer request may be generated, based upon the at least one value, and the data structure may be modified. The another data transfer request may request at least some of the another portion of the data. The data structure, as modified, may comprise at least one value indicating that the target has not completed performing the another data transfer request.

### RELATED APPLICATION

This subject application is related to co-pending U.S. patent application Ser. No. 10/659,959 (Attorney Docket No. P17157) filed Sep. 10, 2003, entitled “Request Conversion.” This co-pending application is assigned to the same Assignee as the subject application.

### FIELD

This disclosure relates to request conversion.

### BACKGROUND

In one conventional data storage arrangement, a computer node includes a host processor and a host bus adapter (HBA). The HBA is coupled to a data storage device. A host processor in the computer node issues a first data transfer request that complies with a first protocol. The HBA converts the request into one or more other data transfer requests that comply with a second protocol, and issues the one or more other requests to the data storage device. In this arrangement, it is possible that the data transfer amount requested by a single data transfer request according to the first protocol may exceed the maximum data transfer amount that a single data transfer request according to the second protocol can request.

One proposed solution to the problem is to restrict the maximum data transfer amount that can be requested by a single data transfer request according to the first protocol such that it is less than or equal to the maximum data transfer amount that can be requested by a single data transfer request according to the second protocol. Disadvantageously, one or more processes that implement the first protocol are modified to carry out this proposed solution; this may limit the types of processes that may be executed to implement the first protocol. Also disadvantageously, a greater number of data transfer requests according to the first protocol may be generated and issued; this may increase the amount of processing resources that may be consumed to generate data transfer requests according to the first protocol.

In another proposed solution, if the data transfer amount requested by a data transfer request according to the first protocol exceeds the maximum data transfer amount that can be requested by a single data transfer request according to the second protocol, the HBA generates and stores in memory a linked list of separate data transfer requests according to the second protocol. The respective data transfer amounts requested by the separate requests sum to the data transfer amount requested by the data transfer request according to the first protocol. Disadvantageously, implementation of this proposed solution consumes an undesirably large amount of memory. Also disadvantageously, this proposed solution fails to appreciate possible data proximity in cache memory; this may result in inefficient use of cache memory.

Also, depending upon the features of the second protocol, the data storage device may be capable of receiving, in accordance with the second protocol, prior to completely executing an earlier-received data transfer request from the HBA, one or more additional data transfer requests from the HBA. In such an arrangement, the data storage device may be capable of executing, in parallel, a plurality of data transfer requests according to the second protocol. Conventional techniques for addressing this situation typically involve generating a linked list of separate data transfer requests, in accordance with the second protocol, in memory in the HBA, and/or only permitting the data storage device to execute a single respective data storage request at any given time. Unfortunately, the former technique is subject to some or all of the aforesaid disadvantages. In the latter technique, the HBA is not permitted to issue another data transfer request to the data storage device until after the data storage device has fully completed all previous data transfer requests. Disadvantageously, this prohibits the HBA from being able to take advantage of the capability of the data storage device to receive, prior to completely executing a data transfer request, one or more additional data transfer requests from the HBA, and/or the capability of the data storage device to execute, in parallel, a plurality of data transfer requests according to the second protocol.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram that illustrates a system embodiment.

FIG. 2 illustrates data structures according to an embodiment.

FIG. 3 illustrates data whose transfer may be requested according to an embodiment.

FIG. 4 is a flowchart that illustrates operations that may be performed according to an embodiment.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

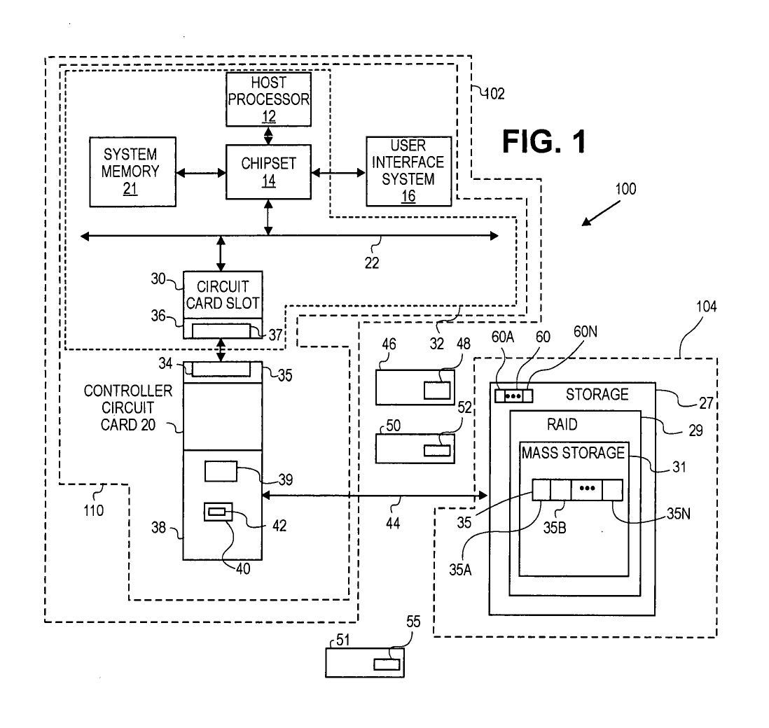

FIG. 1 illustrates a system embodiment 100. System 100 may include a host processor 12 coupled to a chipset 14. Host processor 12 may comprise, for example, an Intel® Pentium® IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, computer-readable system memory 21, and a user interface system 16 to each other and to a bus system 22. Chipset 14 may also include an input/output (I/O) bridge/hub system (not shown) that may couple the host bridge/bus system to bus 22. Chipset 14 may comprise one or more integrated circuit chips, such as those selected from integrated circuit chipsets commercially available from the assignee of the subject application (e.g., graphics memory and I/O controller hub chipsets), although one or more other integrated circuit chips may also, or alternatively be used, without departing from this embodiment. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

System embodiment 100 may comprise storage 27. Storage 27 may comprise a redundant array of independent disks (RAID) 29 including mass storage 31. Storage 27 may be communicatively coupled to an I/O controller circuit card 20 via one or more communication links 44. As used herein, “storage” means one or more apparatus and/or media into, and from which, data and/or commands may be stored and retrieved, respectively. Also as used herein, “mass storage” means storage that is capable of non-volatile storage of data and/or commands, and, for example, may include, in this embodiment, without limitation, magnetic, optical, and/or semiconductor storage devices. In this embodiment, card 20 may comprise, for example, an HBA. Of course, the number of storage devices that may be comprised in mass storage 31, RAID 29, and/or storage 27, and the number of communication links 44 may vary without departing from this embodiment.

The RAID level that may be implemented by RAID 29 may be 0, 1, or greater than 1. Depending upon, for example, the RAID level implemented in RAID 29, the number of mass storage devices that may be comprised in mass storage 31 may vary so as to permit the number of these mass storage devices to be at least sufficient to implement the RAID level implemented in RAID 29. Alternatively, without departing from this embodiment, RAID 29 and/or mass storage 31 may be eliminated from storage 27.

Processor 12, system memory 21, chipset 14, bus 22, and circuit card slot 30 may be comprised in a single circuit board, such as, for example, a system motherboard 32. Host computer system operative circuitry 110 may comprise system motherboard 32.

In this embodiment, card 20 may exchange data and/or commands with storage 27, RAID 29, and/or mass storage 31 via one or more links 44, in accordance with, e.g., a Serial Advanced Technology Attachment II (SATA II) protocol. Of course, alternatively, I/O controller card 20 may exchange data and/or commands with storage 27, RAID 29, and/or mass storage 31 in accordance with other and/or additional communication protocols, without departing from this embodiment.

In accordance with this embodiment, if controller card 20 exchanges data and/or commands with storage 27, RAID 29, and/or mass storage 31 in accordance with an SATA II protocol, the SATA II protocol may comply or be compatible with the protocol described in “Serial ATA II: Extensions To Serial ATA 1.0a,” Revision 1.2, published on Aug. 27, 2004 by the Serial ATA Working Group. For example, in accordance with this embodiment, an initiator 102 in accordance with SATA II protocol may comprise circuitry 110 and/or a portion of circuitry 110 (such as, for example, card 20, processor 40, and/or circuitry 38), and a target 104 in accordance with SATA II protocol may comprise storage 27 and/or a portion of storage 27 (such as, for example, RAID 29 and/or one or more storage devices comprised in mass storage 31). As is known to those skilled in the art, SATA II protocol supports a feature called “native command queuing” (NCQ) which permits a target to execute in parallel, at least in part, a plurality of data transfer requests from an initiator.

In accordance with SATA II protocol, storage 27 may comprise and maintain an SATA II SActive register (not shown) that may store a tag bit map 60. Bit map 60 may comprise a plurality of binary values 60A . . . 60N. In accordance with SATA II protocol, the number of binary values 60A . . . 60N may be equal to the maximum possible number of SATA II data transfer requests that storage 27 may be capable of executing, at least in part, in parallel. Bit map 60 may function as a scoreboard identifying, at least in part, one or more data transfer requests that are currently being executed by target 104 (e.g., storage 27). For example, each possible value of bit map 60 may represent a respective tag value that may be assigned to identify a respective data transfer request that target 104 may currently be executing. Prior to issuing a data transfer request to target 104, initiator 102 (e.g., processor 40) may obtain from target 104 the current value of bit map 60, and based, at least in part, upon this value, the initiator 102 may determine whether the target 104 is currently capable of receiving and executing a data transfer request from the initiator 102. For example, if a particular binary value (e.g., value 60A) in bit map 60 is set (e.g., equal to unity), this may indicate that a data transfer request that has been assigned the tag that corresponds to the corresponding bit map value (e.g., the value of bit map 60 that exists when value 60A is set, but all of the remaining binary values in bit map 60 are unset) is presently being executed by target 104, and therefore, is unavailable for assignment to another data transfer request until the target 104 completely finishes its execution of this currently executing request. After the target 104 completely finishes executing a data transfer request, the target 104 may unset the bit value in bit map 60 that corresponds to the tag value that has been assigned to that data transfer request. Similarly, after the target 104 receives a new data transfer request from the initiator 102, target 104 may set the bit value in bit map 60 that corresponds to the tag value that has been assigned to that data transfer request. Thus, if all of the binary values 60A . . . 60N are set, this may indicate that the target 104 is currently executing the maximum of data transfer requests that it may be capable of executing in accordance with SATA II protocol, and therefore, prior to issuing another data transfer request to target 104, initiator 102 may wait until target 104 completes execution of previously received data transfer request and indicates such completion by unsetting the binary value in bit map 60 that corresponds to this completed data transfer request.

Depending upon, for example, whether bus 22 comprises a PCI Express™ bus or a PCI-X bus, circuit card slot 30 may comprise, for example, a PCI Express™ or PCI-X bus compatible or compliant expansion slot or interface 36. Interface 36 may comprise a bus connector 37 may be electrically and mechanically mated with a mating bus connector 34 that may be comprised in a bus expansion slot or interface 35 in circuit card 20.

As used herein, “circuitry” may comprise, for example, singly or in any combination, hardwired circuitry, programmable circuitry, state machine circuitry, and/or memory that may comprise program instructions that may be executed by programmable circuitry. In this embodiment, circuit card 20 may comprise operative circuitry 38 which may comprise computer-readable memory 39 and I/O processor 40. Memory 21 and/or memory 39 may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory 21 and/or memory 39 may comprise other and/or later-developed types of computer-readable memory.

I/O processor 40 may comprise, for example, an Intel® i960® RX, IOP310, and/or IOP321 I/O processor commercially available from the Assignee of the subject application. Of course, alternatively, I/O processor 40 may comprise another type of I/O processor and/or microprocessor, such as, for example, an I/O processor and/or microprocessor that is manufactured and/or commercially available from a source other than the Assignee of the subject application, without departing from this embodiment. Processor 40 may comprise computer-readable memory 42. Memory 42 may comprise, for example, local cache memory accessible by processor 40.

Machine-readable program instructions may be stored in memory 21 and/or memory 39. These instructions may be accessed and executed by host processor 12, I/O processor 40, circuitry 110, and/or circuitry 38. When executed by host processor 12, I/O processor 40, circuitry 110, and/or circuitry 38, these instructions may result in host processor 12, I/O processor 40, circuitry 110, and/or circuitry 38 performing the operations described herein as being performed by host processor 12, I/O processor 40, circuitry 110, and/or circuitry 38.

Slot 30 and card 20 may be constructed to permit card 20 to be inserted into slot 30. When card 20 is properly inserted into slot 30, connectors 34 and 36 become electrically and mechanically coupled to each other. When connectors 34 and 36 are so coupled to each other, circuitry 38 in card 20 becomes electrically coupled to bus 22 and may exchange data and/or commands with system memory 21, host processor 12, and/or user interface system 16 via bus 22 and chipset 14.

Alternatively, without departing from this embodiment, some or all of operative circuitry 38 may not be comprised in card 20, but instead, may be comprised in other structures, systems, and/or devices in system 100. These other structures, systems, and/or devices may be, for example, comprised in motherboard 32, coupled to bus 22, and exchange data and/or commands with other components (such as, for example, system memory 21, host processor 12, and/or user interface system 16) in system 100. For example, without departing from this embodiment, some or all of circuitry 38 and/or other circuitry (not shown) may be comprised in chipset 14, chipset 14 may be coupled to storage 27 via one or more links 44, and chipset 14 may exchange data and/or commands with storage 27 in a manner that is similar to the manner in which circuitry 38 is described herein as exchanging data and/or commands with storage 27.

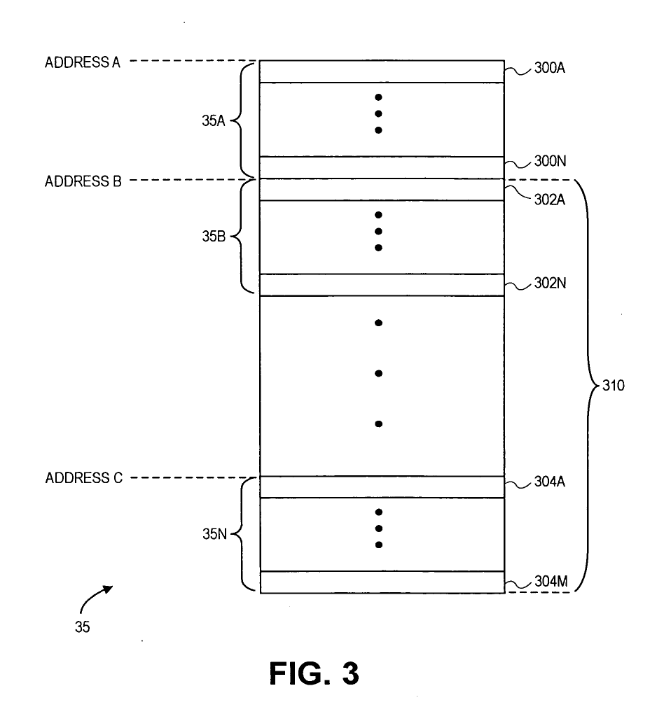

Mass storage 31 may be capable of storing a plurality of mutually contiguous portions 35A, 35B, . . . 35N of data 35. Each of these portions 35A, 35B, . . . 35N may comprise a plurality of mutually contiguous logical or physical sectors. For example, as shown in FIG. 3, portion 35A may comprise mutually contiguous logical or physical sectors 300A . . . 300N, portion 35B may comprise mutually contiguous logical or physical sectors 302A . . . 302N, and portion 35N may comprise mutually contiguous logical or physical sectors 304A . . . 304N. Each of the sectors comprised in portions 35A, 35B . . . 35N may begin and end at respective logical and/or physical addresses in mass storage 31. Additionally, these sectors may be comprised in logical and/or physical blocks in mass storage 31. For example, the first sector 300A of portion 35A may begin at a logical or physical block address in mass storage 31 identified and/or specified by “ADDRESS A” in FIG. 3. The first sector 302A of portion 35B may begin at a logical or physical block address in mass storage 31 identified and/or specified by ADDRESS B in FIG. 3. The first sector 304A of portion 35N may begin at a logical or physical block address in mass storage 31 identified and/or specified by “ADDRESS C” in FIG. 3.

Although the respective sectors comprised in the portions 35A, 35B, . . . 35N have been previously described as being mutually contiguous, they may not be mutually contiguous, without departing from this embodiment. Likewise, without departing from this embodiment, the logical or physical blocks may not be mutually contiguous. Additionally, without departing from this embodiment, portions 35A, 35B, . . . 35N may not be mutually contiguous.

With reference now being made to FIGS. 1 to 4, operations 400 will be described that may be performed in accordance with an embodiment. After, for example, a reset of system 100, host processor 12 may generate and issue, via chipset 14, bus 22, and slot 30, a data transfer request. As used herein, a “data transfer request” means a request and/or command to transfer data. As used herein, “transferring data” means transmitting, reading, writing, storing, and/or retrieving data. In this embodiment, this data transfer request may be in accordance with a first protocol. As used herein, a “protocol” means one or more rules governing exchange of data, commands, and/or requests between or among two or more entities. In this embodiment, this first protocol may comprise, at least in part, for example, a Small Computer Systems Interface (SCSI) protocol described, for example, in American National Standards Institute (ANSI) Small Computer Systems Interface-2 (SCSI-2) ANSI X3.131-1994 Specification. However, without departing from this embodiment, this first protocol may comprise other and/or additional protocols.

After card 20 receives the data transfer request from host processor 12, processor 40 may examine the request to determine the amount of data requested by the request to be transferred. For example, in this embodiment, the data transfer request issued from the host processor 12 to card 20 may request that data 35 be read, retrieved, and/or transferred from mass storage 31 to host processor 12. If the data transfer request issued from host processor 12 to card 20 is in accordance with a SCSI protocol, then the request may comprise, for example, a SCSI request block that may contain one or more parameters that may indicate the amount of data comprised in data 35. Processor 40 may examine these one or more parameters to determine this amount of data 35 requested to be transferred from mass storage 31 to host processor 12.

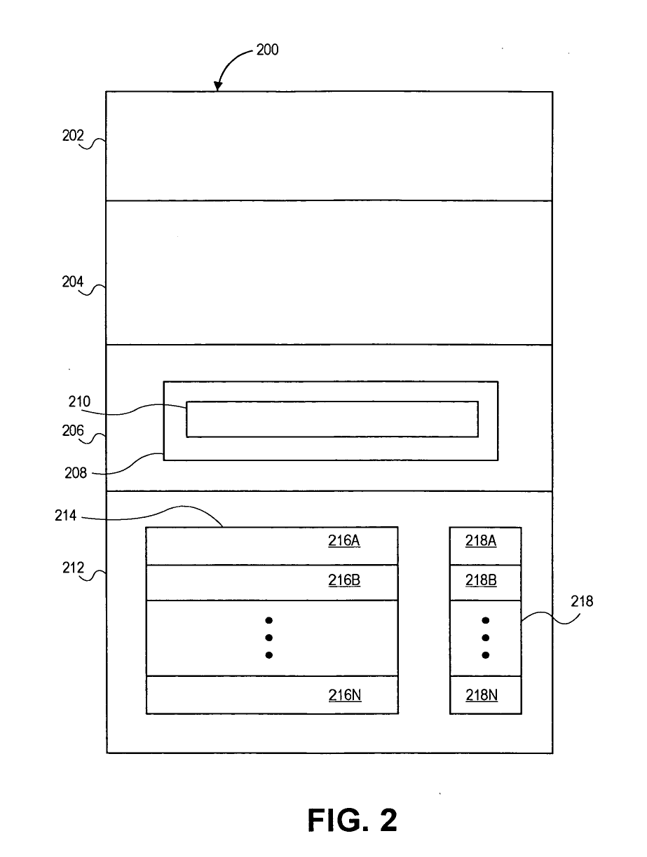

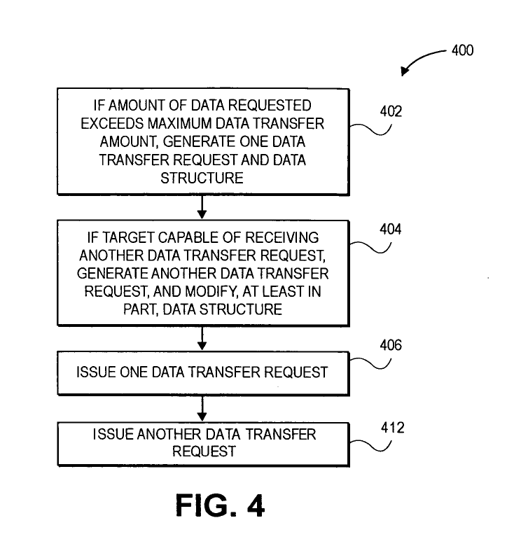

If processor 40 determines that the amount of data 35 requested to be transferred from mass storage 31 to host processor 12 exceeds a maximum data transfer amount permitted to be requested by a single data transfer request according to a second protocol, in response at least in part to the request from the host processor 12, processor 40 may generate a data transfer request according to the second protocol and a data structure, as illustrated by operation 402 in FIG. 4. As used herein, a “data structure” means a set, collection, and/or group of one or more values and/or variables that may be referenced and/or referred to collectively as a single unit. For example, in this embodiment, as stated previously, controller card 20 may exchange data and/or commands with storage 27, RAID 29, and/or mass storage 31 in accordance with an SATA II protocol; in this embodiment, this second protocol may comprise an SATA II protocol. This SATA II protocol may specify a maximum amount of data that a single data transfer request in accordance with SATA II protocol may request to be transferred (e.g., without violating the SATA II protocol). As is known to those skilled in art the art, the maximum amount of data that single data transfer request may request to be transferred in accordance with SCSI protocol may be greater than the maximum amount of data that single data transfer request may request to be transferred in accordance with SATA II protocol. In this embodiment, if processor 40 determines that the amount of data 35 requested to be transferred by the data transfer request issued by the host processor 12 exceeds the maximum amount of data that a single data transfer request in accordance with SATA H protocol may request to be transferred, processor 40 may generate, as a result of operation 402, a data transfer request 46 in accordance with SATA II protocol and a data structure 212 (See FIG. 2). Data transfer request 46 may request that a portion (e.g., portion 35A) of data 35 whose transfer was requested by host processor 12 be read, retrieved, and transferred from mass storage 31 to circuitry 38.

For example, in this embodiment, with specific reference now being made to FIG. 2, as part of operation 402, processor 40 may store in memory 42 request block 200. Block 200 may comprise, for example, a plurality of data structures 202, 204, 206, and 212. Data structures 202 and 204 may comprise respective values that may identify and/or specify, respectively, SCSI context information and command descriptor block information obtained from the data transfer request issued by host processor 12. Data structure 206 may comprise a command task file 208 that may comprise one or more values 210 that may indicate, at least in part, one or more parameters 48 in request 46 in accordance with SATA II protocol. These one or more parameters 48 may identify, at least in part, the portion 35A of data 35 requested by request 46 to be transferred from mass storage 31 to circuitry 38.

In accordance with this embodiment, data structure 212 may comprise one or more values 214 that may identify, at least in part, another portion 310 (e.g., comprising portions 35B . . . 35N) of data 35 remaining to be transferred to circuitry 38 from mass storage 31, after storage 27 has executed request 46, after portion 35A, whose transfer to circuitry 38 is requested by request 46, has been transferred from mass storage 31 to circuitry 38. For example, in this embodiment, one or more values 214 may comprise a plurality of values 216A, 216B, . . . 216N. Values 216A and 216B may identify, respectively, at least in part, the amount of data 35 remaining, after execution of the data transfer request most recently generated by processor 40, to be transferred from mass storage 31 to circuitry 38, and the location of the portion (e.g., portion 35B) of data 35 whose transfer will be requested by the next data transfer request (e.g., request 50) to be generated by processor 40. The execution by storage 27 of this next data transfer request 50 may result in transfer of another portion 35B of data 35. Value 216A may be specified by and/or in terms (e.g., units) of, at least in part, a number of sectors of mass storage 31. Additionally, the location of the portion 35B of data 35 whose transfer will be requested by the next data transfer request 50 to be generated by processor 40 may be identified and/or specified by value 216B by and/or in terms of, at least in part, a starting address (e.g., ADDRESS B) of this portion 35B of data 35.

Although data structures 202, 204, 206, and 212 have been described previously as being comprised in single contiguous block 200 in memory 42, data structures 202, 204, 206, and/or 212 may not be mutually contiguous with each other in memory 42. Other modifications are also possible without departing from this embodiment.

In this embodiment, if, as part of operation 402, processor 40 determines that the amount of data 35 requested by processor 12 exceeds the maximum data transfer amount permitted to be requested by a single data transfer request according to the second protocol, each of the data transfer requests generated by processor 40 in accordance with the second protocol in response to and/or in order to satisfy, at least in part, the request from processor 12 according to the first protocol, with the exception of the last such data transfer request so generated by processor 40, may request transfer of the maximum data transfer amount permitted by a single data transfer request according to the second protocol. Of course, without departing from this embodiment, data transfer requests generated by processor 40 may request transfer of one or more other data transfer amounts.

In accordance with this embodiment, data structure 212 may comprise a bit map 218. As used herein, a “bit map” means one or more symbols and/or values. In this embodiment, bit map 218 may comprise binary values 218A, 218B, . . . 218N. The size of bit map 218 (i.e., the number of binary values 218A, 218B, . . . 218N comprised in bit map 218) may be equal to the size of bit map 60 (i.e., the number of binary values 60A . . . 60N comprised in bit map 60) in storage 27. As initially generated, each of the binary values 218A, 218B, . . . 218N may be unset. However, as is described below, after processor 40 generates and issues, in response, at least in part, to the data transfer request in accordance with the first protocol from host 12, to storage 27 a respective data transfer request in accordance with the second protocol, processor 40 may set the respective binary value in bit map 218 that corresponds to the respective tag value assigned to the respective data transfer request in accordance with the second protocol. This may result in data structure 212 being modified so as to comprise one or more respective values (e.g., the respective binary value in bit map 218 that is set) that indicate, at least in part, that target 104 has not yet completed performing the respective data transfer request from processor 40. After storage 27 completely finishes a respective data transfer request from processor 40, storage 27 may indicate this to processor 40. In response, at least in part, to this indication from storage 27, processor 40 may modify data structure, at least in part, so as to unset the respective binary value in bit map 218. This may indicate, at least in part, that the target 104 has completed performing the respective data transfer request from target 104.

With reference again being made to FIG. 4, in this embodiment, after processor 40 has generated, as a result of operation 402, the data transfer request 46 and the data structure, processor 40 may determine, as part of operation 404, if the target 104 of the data transfer request 46 is capable of receiving, prior to completion of performance of data transfer request 46 by the target 104, another data transfer request (e.g., request 50) according to the second protocol. For example, processor 40 may obtain and examine bit map 60 to determine how many (if any) tags are available for assignment to new data transfer requests that may be issued from processor 40 to storage 27. If, as a result of its examination of bit map 60, processor 40 determines that there are fewer than two such tags available for assignment, processor 40, as part of operation 404, may determine that target 104 is not capable of receiving, prior to completion of performance of request 46 another request 50. Additionally or alternatively, processor 40 may determine (e.g., using conventional protocol detection techniques) that storage 27 is incapable of implementing NCQ in accordance with SATA II protocol. If processor 40 determines storage 27 is incapable of implementing NCQ, processor 40 may carry out operations in accordance with the aforesaid co-pending U.S. patent application Ser. No. 10/659,959 (Attorney Docket No. P17157) filed Sep. 10, 2003, entitled “Request Conversion.”

If, as part of operation 404, processor 40 determines that there is only one tag available for assignment, processor 40 may set a respective binary value in bit map 218 that corresponds to the tag assigned to be assigned to request 46, may issue request 46, and thereafter, may periodically re-obtain and re-examine bit map 60 to determine when one or more tags again become available for assignment. Conversely, if, as part of operation 404, processor 40 determines that there are no tags available for assignment, processor 40 periodically re-obtain and re-examine bit map 60 to determine when one or more tags are available for assignment. After processor 40 determines that one or more tags are available for assignment, depending upon the number of tags that are available for assignment, processor 40 may perform operations described herein, as appropriate, depending upon the number of tags available for assignment.

Conversely, if, as part of operation 404, processor 40 determines that there are at least two such tags available for assignment, processor 40, also as part of operation 404, may determine that target 104 is capable of receiving, prior to completion of performance of request 46 another request 50. Thereafter, also as part of operation 404, processor 40 may generate another data transfer request 50, and may modify, at least in part, data structure 212 to comprise one or more values that may indicate, at least in part, that target 104 has not completed performing data transfer request 50.

For example, as part of operation 404, processor 40 may modify, at least in part, bit map 218 to set the respective binary values (e.g., values 218A and 218B) that may correspond to the respective tags that are to be assigned to requests 46 and 50. Prior to generating request 50, processor 40 may modify, at least in part, data structure 206, based, at least in part, upon one or more values 214. For example, in this embodiment, processor 40 may modify, at least in part, command task file 208 and/or one or more values 210 to identify, at least in part, portion 35B of data 35 to be requested by request 50 for transfer from mass storage 31 to circuitry 38. Request 50 may comprise one or more parameters that may be indicated, at least in part, by one or more values 210, as modified, at least in part. These one or more parameters may identify, at least in part, the portion 35B of data 35 requested by request 50 to be transferred from mass storage 31 to circuitry 38.

Depending upon the number of portions 35A . . . 35N of data 35 to requested in order to satisfy the host processor's data transfer request, after modifying, at least in part, data structure 206, processor 40 may modify, at least in part, data structure 212 such that one or more values 214 may identify, at least in part, yet another portion of data 35 whose transfer is to be requested by yet another data transfer request (e.g., request 51) to be generated by processor 40; when generated by processor 40, request 51 may include one or more parameters 55 indicating this yet another portion of data 35.

As will be appreciated by those skilled in the art, the number of data transfer requests generated by processor 40, as a result of operation 404, may be limited by the number of tags that processor 40 may determine, as a result of operation 404, to be available for assignment, and the number of portions of data 35 to be transferred to satisfy the host processor's data transfer request. In generating these data transfer requests, as a result of operation 404, processor 40 may modify, at least in part, in accordance with the teachings set forth above, the data structures 206 and 212, as part of operation 404. After generating each of these data transfer requests, processor 40 may initially store them in memory 42 and/or 39. Thereafter, processor 40 may issue the requests 46, 50, and 51 generated as a result of operation 404 to target 104, as illustrated by operation 406.

If the number of portions of data 35 to be transferred to satisfy the host processor's data transfer request exceeds the number of available tags, after issuing requests 46, 50, and 51, processor 40 may periodically re-obtain and re-examine bit map 60, and may periodically execute one or more additional iterations of operation 404, as appropriate and in accordance with the teachings described above, to generate additional data transfer requests requesting the remaining portion(s) of data 35. These additional data transfer requests may be issued to target 104. In response, at least in part, to requests 46, 50, and 51, storage 27 may execute requests 46, 50, and 51. This may result in mass storage 31 reading, retrieving, and/or transmitting the respective portions of data 35 requested by such requests to circuitry 38. Circuitry 38 may store these respective portions of data 35 in memory 39 and/or memory 21.

After storage 27 has completely executed one or more respective requests 46, 50, and/or 51, storage 27 may unset the one or more respective binary values in bit map 60 that may correspond to the one or more respective tags assigned to these one or more respective requests, and storage 27 may signal circuitry 38. This may result in processor 40 obtaining and examining bit map 60. The unsetting of these one or more respective binary values in bit map 60 may function as indication from target 104 to processor 40 that target 104 has completed executing one or more requests 46, 50, and/or 51. In response, at least in part, to such indication, processor 40 may modify, at least in part, one or more respective values in bit map 218 (e.g., values 218A, 218B, and/or 218N) that may correspond to one or more respective tags assigned to one or more requests 46, 50, and/or 51. For example, processor 40 may unset these one or more respective values in bit map 218.

After circuitry 38 has received all of the portions of data 35, circuitry 38 may transmit to host processor 12 the data 35 whose transfer was requested by host processor 12. Alternatively or additionally, circuitry 38 may transmit to and store in memory 21 data 35, and may indicate to host processor 12 that data 35 has been retrieved from storage 27, and is available to host processor 12 in memory 21.

As stated previously, the number of portions 35A, 35B, . . . 35N may vary without departing from this embodiment. Accordingly, the number of data transfer requests generated and issued to storage 27 by processor 40 may vary without departing from this embodiment.

Thus, one system embodiment may comprise a circuit card capable of being inserted in a circuit card slot that is comprised in a circuit board. The circuit card may comprise circuitry capable of generating, if an amount of data requested to be transferred by a data transfer request according to a first protocol exceeds a maximum data transfer amount permitted to be requested by a single data transfer request according to a second protocol, one data transfer request according to the second protocol and a data structure. The one data transfer request may request transfer of a portion of the data. The data structure may comprise one or more values identifying, at least in part, another portion of the data. The circuitry also be capable of, if a target of the one data transfer request is capable of receiving, prior to completion of performance of the one data transfer request, another data transfer request according to the second protocol, generating the another data transfer request, and modifying, at least in part, the data structure. The another data transfer request may be generated, based at least in part upon the one or more values. The another data transfer request may request at least a part of the another portion of the data. The data structure may be modified, at least in part, to comprise one or more other values indicating, at least in part, that the target has not completed performing the another data transfer request.

These features of this system embodiment may permit fewer data transfer requests according to the first protocol to be generated and issued compared to the prior art. Advantageously, this may reduce the amount of processing resources that may be consumed to generate data transfer requests according to the first protocol. Additionally, these features of this system embodiment may obviate generating and storing in memory a linked list of separate data transfer requests according to the second protocol, may permit data comprised in the data structures of this system embodiment to be loaded into memory more efficiently compared to the prior art, and may permit these data structures to be modified, at least in part, and reused, at least in part. Advantageously, these features of this system embodiment may permit the amount of memory consumed to implement this system embodiment to be reduced, may reduce the amount of memory processing, and may permit memory resources (e.g., cache memory resources) to be used more efficiently compared to the prior art.

Also, these features of this system embodiment may permit the circuitry of this system embodiment to be able to generate and issue to the target a data transfer request, prior to the target's completing the execution of another data transfer request. Advantageously, this may permit the circuitry of this system embodiment to be able to take advantage of the capability of the target to receive, prior to completing execution of a data transfer request, one or more additional data transfer requests from the circuitry, and/or the capability of the target to execute, in parallel, at least in part, a plurality of data transfer requests according to the second protocol.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A method comprising:
if an amount of data requested to be transferred by a data transfer request according to a first protocol exceeds a maximum data transfer amount permitted to be requested by a single data transfer request according to a second protocol, generating one data transfer request according to the second protocol and a data structure, the one data transfer request requesting transfer of a portion of the data, the data structure comprising one or more values identifying, at least in part, another portion of the data; and
if a target of the one data transfer request is capable of receiving, prior to completion of performance of the one data transfer request, another data transfer request according to the second protocol:
generating, based at least in part upon the one or more values, the another data transfer request, the another data transfer request requesting at least a part of the another portion of the data; and
modifying, at least in part, the data structure to comprise one or more other values indicating, at least in part, that the target has not completed performing the another data transfer request.

2. The method of claim 1, further comprising:
issuing the one data transfer request to the target; and
issuing, prior to completion of the performance of the one data transfer request by the target, the another data transfer request to the target.

3. The method of claim 1, wherein:
the data structure, as modified, comprises at least one value that identifies, at least in part, a remaining portion of the data, the remaining portion being a subset of the data distinct from both the another portion and the part of the data.

4. The method of claim 1, wherein:
the first protocol comprises a Small Computer Systems Interface (SCSI) protocol; and
the second protocol comprises a Serial Advanced Technology Attachment II (SATA II) protocol utilizing Native Command Queuing (NCQ).

5. The method of claim 1, further comprising:
in response, at least in part, to an indication that the target has completed the another data transfer request, modifying, at least in part, the one or more other values to indicate that the target has completed the another data transfer request.

6. The method of claim 1, further comprising:
receiving from the target an indication of whether the target is capable of receiving, prior to the completion of the performance of the one data transfer request, another data transfer request.

7. The method of claim 6, wherein:
the indication is based, at least in part, upon a first bit map identifying, at least in part, one or more data transfer requests currently being executed by the target; and
a second bit map data comprises the one or more other values, the second bit map having a size equal to a size of the first bit map.

8. The method of claim 1, further comprising:
modifying, at least in part, another data structure based, at least in part, upon the one or more values, the another data structure comprising, prior to the modifying at least in part of the another data structure, one or more additional values indicating, at least in part, one or more parameters of the one data transfer request.

9. An apparatus comprising:
circuitry capable of generating, if an amount of data requested to be transferred by a data transfer request according to a first protocol exceeds a maximum data transfer amount permitted to be requested by a single data transfer request according to a second protocol, one data transfer request according to the second protocol and a data structure, the one data transfer request requesting transfer of a portion of the data, the data structure comprising one or more values identifying, at least in part, another portion of the data; and
the circuitry also being capable of, if a target of the one data transfer request is capable of receiving, prior to completion of performance of the one data transfer request, another data transfer request according to the second protocol:
generating, based at least in part upon the one or more values, the another data transfer request, the another data transfer request requesting at least a part of the another portion of the data; and
modifying, at least in part, the data structure to comprise one or more other values indicating, at least in part, that the target has not completed performing the another data transfer request.

10. The apparatus of claim 9, wherein the circuitry is also capable of:
issuing the one data transfer request to the target; and
issuing, prior to completion of the performance of the one data transfer request by the target, the another data transfer request to the target.

11. The apparatus of claim 9, wherein:
the data structure, as modified, comprises at least one value that identifies, at least in part, a remaining portion of the data, the remaining portion being a subset of the data distinct from both the another portion and the part of the data.

12. The apparatus of claim 9, wherein:
the first protocol comprises a Small Computer Systems Interface (SCSI) protocol; and
the second protocol comprises a Serial Advanced Technology Attachment II (SATA II) protocol utilizing Native Command Queuing (NCQ).

13. The apparatus of claim 9, wherein the circuitry is also capable of:
in response, at least in part, to an indication that the target has completed the another data transfer request, modifying, at least in part, the one or more other values to indicate that the target has completed the another data transfer request.

14. The apparatus of claim 9, wherein the circuitry is also capable of:
receiving from the target an indication of whether the target is capable of receiving, prior to the completion of the performance of the one data transfer request, another data transfer request.

15. The apparatus of claim 14, wherein:
the indication is based, at least in part, upon a first bit map identifying, at least in part, one or more data transfer requests currently being executed by the target; and
a second bit map data comprises the one or more other values, the second bit map having a size equal to a size of the first bit map.

16. The apparatus of claim 9, wherein the circuitry is also capable of:
modifying, at least in part, another data structure based, at least in part, upon the one or more values, the another data structure comprising, prior to the modifying at least in part of the another data structure, one or more additional values indicating, at least in part, one or more parameters of the one data transfer request.

17. One or more storage media storing instructions that when executed by a machine result in performance of operations comprising:
if an amount of data requested to be transferred by a data transfer request according to a first protocol exceeds a maximum data transfer amount permitted to be requested by a single data transfer request according to a second protocol, generating one data transfer request according to the second protocol and a data structure, the one data transfer request requesting transfer of a portion of the data, the data structure comprising one or more values identifying, at least in part, another portion of the data; and
if a target of the one data transfer request is capable of receiving, prior to completion of performance of the one data transfer request, another data transfer request according to the second protocol:
generating, based at least in part upon the one or more values, the another data transfer request, the another data transfer request requesting at least a part of the another portion of the data; and
modifying, at least in part, the data structure to comprise one or more other values indicating, at least in part, that the target has not completed performing the another data transfer request.

18. The one or more storage media of claim 17, wherein the operations also comprise:
issuing the one data transfer request to the target; and
issuing, prior to completion of the performance of the one data transfer request by the target, the another data transfer request to the target.

19. The one or more storage media of claim 17, wherein:
the data structure, as modified, comprises at least one value that identifies, at least in part, a remaining portion of the data, the remaining portion being a subset of the data distinct from both the another portion and the part of the data.

20. The one or more storage media of claim 17, wherein:
the first protocol comprises a Small Computer Systems Interface (SCSI) protocol; and
the second protocol comprises a Serial Advanced Technology Attachment II (SATA II) protocol utilizing Native Command Queuing (NCQ).

21. The one or more storage media of claim 17, wherein the operations also comprise:
in response, at least in part, to an indication that the target has completed the another data transfer request, modifying, at least in part, the one or more other values to indicate that the target has completed the another data transfer request.

22. The one or more storage media of claim 17, wherein the operations also comprise:
receiving from the target an indication of whether the target is capable of receiving, prior to the completion of the performance of the one data transfer request, another data transfer request.

23. The one or more storage media of claim 22, wherein:
the indication is based, at least in part, upon a first bit map identifying, at least in part, one or more data transfer requests currently being executed by the target; and
a second bit map data comprises the one or more other values, the second bit map having a size equal to a size of the first bit map.

24. The one or more storage media of claim 17, wherein the operations also comprise:
modifying, at least in part, another data structure based, at least in part, upon the one or more values, the another data structure comprising, prior to the modifying at least in part of the another data structure, one or more additional values indicating, at least in part, one or more parameters of the one data transfer request.

25. A system comprising:
a circuit card capable of being inserted in a circuit card slot that is comprised in a circuit board, the circuit card comprising:
circuitry capable of generating, if an amount of data requested to be transferred by a data transfer request according to a first protocol exceeds a maximum data transfer amount permitted to be requested by a single data transfer request according to a second protocol, one data transfer request according to the second protocol and a data structure, the one data transfer request requesting transfer of a portion of the data, the data structure comprising one or more values identifying, at least in part, another portion of the data; and
the circuitry also being capable of, if a target of the one data transfer request is capable of receiving, prior to completion of performance of the one data transfer request, another data transfer request according to the second protocol:
generating, based at least in part upon the one or more values, the another data transfer request, the another data transfer request requesting at least a part of the another portion of the data; and
modifying, at least in part, the data structure to comprise one or more other values indicating, at least in part, that the target has not completed performing the another data transfer request.

26. The system of claim 25, further comprising the circuit board.

27. The system of claim 26, wherein:
the circuit board also comprises a processor and a bus via which the processor is coupled to the slot.

28. The system of claim 25, wherein:
the target comprises storage; and
the storage is coupled to the card via one or more communication links in accordance with the second protocol.
